(19) United States
(12) Patent Application Publication
(10) Pub. No.: US 2009/0145565 A1
(43) Pub. Date: Jun. 11, 2009

(54) METHOD FOR THE PRODUCTION OF CREPE PAPER

(75) Inventors: Anton Esser, Mannheim (DE); Friedrich Linhart, Heidelberg (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/718,158

(22) PCT Filed: Oct. 20, 2005
(86) PCT No.: PCT/EP05/11278

§ 371 Date: Apr. 27, 2007

(30) Foreign Application Priority Data
Oct. 29, 2004 (DE) 10 2004 052 957.4

(51) Int. Cl. B31F 1/12

(52) U.S. Cl. 162/111

(57) ABSTRACT

A process for the production of crepe paper by adhesive bonding of a paper web with the aid of an organic synthetic polymer or mixtures comprising said polymer to a creping cylinder, compression and removal of the crepe paper from the creping cylinder, the organic synthetic polymer used being at least one polymer comprising vinylamine units.

The invention relates to a process for the production of crepe paper by adhesive bonding of a moist paper web with the aid of an organic synthetic polymer as a creping assistant to the creping cylinder, compression and removal of the crepe paper from the creping cylinder.

Papers which are used for cleaning purposes or for drying, such as hand towels, napkins, tissues, kitchen cloths, lavatory paper or industrial cleaning cloths, have to be soft and flexible, adapt to unevenness and be capable of rapidly absorbing liquids by application to a large area. The paper softness required for this purpose is obtained either by the choice of suitable fibers, by treatment of the paper by mechanical means or by suitable papermaking processes.

A proven mechanical means for softening paper products is creping. In this procedure, the wet paper web is fed to a large polished drying cylinder, i.e. the creping cylinder, for drying, generally in the course of the papermaking, said paper web being lightly adhesively bonded to said creping cylinder with the aid of a creping assistant or a mixture thereof. In modern processes, for example the TAD process (trough air drying), the already dry paper web is fed to the polished metal cylinder and lightly adhesively bonded by means of a creping assistant, also referred to below as adhesive, or a mixture which comprises such an assistant. At a certain point, a sharp blade or edge, i.e. a doctor blade, is pressed against the drying cylinder. Here, the paper web is compressed, lifted off the cylinder and transported onwards with reduced tension and at a reduced speed for rolling up. Depending on the desired extent, this compression imparts transverse folds of desired size, i.e. the creping, to the paper. The stiffness of the paper is thus reduced and the desired softness established.

The creping of the paper is effected in general in the papermaking process. It is, however, also possible to crepe an already dry paper. The creping can therefore also be carried out independently of the papermaking by moistening the paper, for example, with an aqueous solution of a suitable adhesive.

Problem-free and optimum creping depends on various factors, such as the properties of the paper stock, for example the chemicals used therein and the surface charge of the fibers, on the surface and the temperature of the creping cylinder, on the machine speed, and on the sharpness and the feed angle of the doctor blade. Creping demands a very high level of experience on the part of the papermakers. In particular it must be possible to bond the paper on the drying cylinder so that it does not fly off due to the centrifugal force at the high machine speeds, is not lifted off by the doctor blade without being compressed and, on the other hand, is not bonded too strongly on the drying cylinder and hence cannot be removed intact and cleanly from the cylinder by the doctor blade. In addition, the creping assistant is not permitted to form any hard, brittle and firmly adhering coating which impairs the smoothness of the polished cylinder and leaves marks on the paper. The coating should be flexible, should substantially become detached with the paper and should be constantly replaced. In order to be able to master this balancing act, papermakers use adhesives and adhesive mixtures as creping assistants, which are frequently also combined with release agents.

Examples of known adhesives, which are applied either to the drying cylinder or to the paper web and which, if appropriate, also comprise other adhesives, anchoring agents or release agents, are polyvinyl alcohols, copolymers of ethylene and vinyl acetate, polyvinyl acetate, polyacrylates and heat-curable, cationic polyamidoamine resins. The last-mentioned resins are heat-curable condensates of a polyamidoamine and epichlorohydrin, which still comprise reactive groups which crosslink, for example, on heating to relatively high temperatures. Such resins are used, for example, as so-called wet strength agents in the production of tissue paper. However, owing to their reactivity, they cannot be easily handled as creping assistants because the polymer coating on the creping cylinder frequently becomes irregular, hard and brittle so that production and quality problems occur during production. Since the wet strength resins have a relatively high concentration of chloride ions, marked corrosion of the creping cylinder may occur when said resins are used as creping assistants. Frequently, water-soluble inorganic phosphates are also used as additional anchoring agents.

In the process disclosed in EP-A 0 856 083 and intended for the creping of paper, water-soluble polyamidoamines crosslinked with epichlorohydrin and not heat-curable or modified polyamidoamines in the form of aqueous solutions are applied as adhesive directly to the surface of a creping drum.

The adhesives disclosed in U.S. Pat. No. 5,602,209 and intended for the creping of paper comprise from 1 to 25% by weight of polyoxazoline and a polyamidoamine/epichlorohydrin resin. However, polyoxazoline can also be combined with other polymers, for example with polyvinylamides, polyvinyl alcohols, glyoxylated polyvinylamides, polyethylene oxide, polyethylenimine, polyvinylpyrrolidone and Carbowax® polyethylene glycols. As is evident from the examples, the efficiency of combinations with polyoxazoline and another polymer is higher than the efficiency of the individual polymers.

The prior German Patent Application with the application number DE 102004025861.9 describes the use of (i) polyethylenimines, (ii) reaction products of polyethylenimines with alkyldiketenes, monocarboxylic acids or esters thereof or acid chlorides and (iii) reaction products of polyalkylpolyamines with at least one bischlorohydrin ether or bisglycidyl ether of a polyalkylene glycol as an adhesive in a process for the production of crepe paper.

It was therefore the object of the present invention to provide further adhesives for the creping of paper.

According to the invention, the object is achieved by a process for the production of crepe paper by adhesive bonding of a paper web with the aid of an organic synthetic polymer or mixtures comprising said polymer to a creping cylinder, compression and removal of the crepe paper from the creping cylinder, the organic synthetic polymer used being at least one polymer comprising vinylamine units.

Polymers comprising vinylamine units are known, cf. U.S. Pat. No. 4,421,602, U.S. Pat. No. 5,334,287, EP-A-0 216 387, U.S. Pat. No. 5,981,689, WO-A-00/63295, U.S. Pat. No. 6,121,409 and U.S. Pat. No. 6,132,558. They are prepared by hydrolysis of open-chain polymers comprising N-vinylcarboxamide units. These polymers are obtainable, for example, by polymerization of N-vinylformamide, N-vinyl-N-methylformamide, N-vinylacetamide, N-vinyl-N-methylacetamide, N-vinyl-N-ethylacetamide and N-vinylpropionamide. Said monomers can be polymerized either alone or together with other monomers. N-Vinylformamide is preferred.

Suitable monoethylenically unsaturated monomers which are copolymerized with the N-vinylcarboxamides are all compounds copolymerizable therewith. Examples of these are vinyl esters of saturated carboxylic acids of 1 to 6 carbon atoms, such as vinyl formate, vinyl acetate, N-vinylpyrrolidone, vinyl propionate and vinyl butyrate, and vinyl ethers, such as C₁- to C₆-alkyl vinyl ethers, e.g. methyl or ethyl vinyl ether. Further suitable comonomers are esters of alcohols having, for example, 1 to 6 carbon atoms, amides and nitrites of ethylenically unsaturated C₃- to C₆-carboxylic acids, for example methyl acrylate, methyl methacrylate, ethyl acrylate, ethyl methacrylate and dimethyl maleate, acrylamide and methacrylamide and acrylonitrile and methacrylonitrile.

Further suitable carboxylates are derived from glycols or polyalkylene glycols, in each case only one OH group being esterified, e.g. hydroxyethyl acrylate, hydroxyethyl methacrylate, hydroxypropyl acrylate, hydroxybutyl acrylate, hydroxypropyl methacrylate, hydroxybutyl methacrylate and acrylic acid monoesters of polyalkylene glycols having a molar mass of from 500 to 10 000. Further suitable comonomers are esters of ethylenically unsaturated carboxylic acids with amino alcohols, such as, for example, dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate, dimethylaminobutyl acrylate and diethylaminobutyl acrylate. The basic acrylates can be used in the form of the free bases, of the salts with mineral acids, such as hydrochloric acid, sulfuric acid or nitric acid, of the salts with organic acids, such as formic acid, acetic acid, propionic acid or the sulfonic acids, or in quaternized form. Suitable quaternizing agents are, for example, dimethyl sulfate, diethyl sulfate, methyl chloride, ethyl chloride or benzyl chloride.

Further suitable comonomers are the amides of ethylenically unsaturated carboxylic acids, such as acrylamide, methacrylamide and N-alkylmono- and diamides of monoethylenically unsaturated carboxylic acids having alkyl radicals of 1 to 6 carbon atoms, e.g. N-methylacrylamide, N,N-dimethylacrylamide, N-methylmethacrylamide, N-ethylacrylamide, N-propylacrylamide and tert-butylacrylamide, and basic (meth)acrylamides, such as, for example, dimethylaminoethylacrylamide, dimethylaminoethylmethacrylamide, diethylaminoethylacrylamide, diethylaminoethylmethacrylamide, dimethylaminopropylacrylamide, diethylaminopropylacrylamide, dimethylaminopropylmethacrylamide and diethylaminopropylmethacrylamide.

Other suitable comonomers are N-vinylpyrrolidone, N-vinyicaprolactam, acrylonitrile, methacrylonitrile, N-vinylimidazole and substituted N-vinylimidazoles, such as, for example, N-vinyl-2-methylimidazole, N-vinyl-4-methylimidazole, N-vinyl-5-methylimidazole and N-vinyl-2-ethylimidazole, and N-vinylimidazolines, such as, N-vinylimidazoline, N-vinyl-2-methylimidazoline and N-vinyl-2-ethylimidazoline. In addition to being used in the form of the free bases, N-vinylimidazoles and N-vinylimidazolines are also used in a form neutralized with mineral acids or organic acids or in quaternized form, the quaternization preferably being carried out with dimethyl sulfate, diethyl sulfate, methyl chloride or benzyl chloride. Diallyldialkylammonium halides, such as, for example, diallyidimethylammonium chloride, are also suitable.

The copolymers comprise, for example,
from 95 to 5 mol %, preferably from 90 to 10 mol %, of at least one N-vinylcarboxamide, preferably N-vinylformamide, and
from 5 to 95 mol %, preferably from 10 to 90 mol %, of monoethylenically unsaturated monomers
   incorporated in the form of polymerized units. The comonomers are preferably free of acid groups.

The polymerization of the monomers is usually carried out in the presence of free radical polymerization initiators. The homo- and copolymers can be obtained by all known processes; for example, they are obtained by solution polymerization in water, alcohols, ethers or dimethylformamide or in mixtures of various solvents, by precipitation polymerization, inverse suspension polymerization (polymerization of an emulsion of a monomer-containing aqueous phase in an oil phase) and polymerization of a water-in-water emulsion, for example in which an aqueous monomer solution is dissolved or emulsified in an aqueous phase and polymerized with formation of an aqueous dispersion of a water-soluble polymer, as described, for example, in WO 00/27893. After the polymerization, the homo- and copolymers which comprise polymerized N-vinylcarboxamide units are partly or completely hydrolyzed as described below.

In order to prepare polymers comprising vinylamine units, it is preferable to start from homopolymers of N-vinylformamide or from copolymers which are obtainable by copolymerization of
N-vinylformamide with
vinyl formate, vinyl acetate, vinyl propionate, acrylonitrile, methyl acrylate, ethyl acrylate and/or methyl methacrylate
   and subsequent hydrolysis of the homopolymers or of the copolymers with formation of vinylamine units from the polymerized N-vinylformamide units, the degree of hydrolysis being, for example, from 1 to 100 mol %, preferably from 25 to 100 mol %, particularly preferably from 50 to 100 mol % and particularly preferably from 70 to 100 mol %. The degree of hydrolysis corresponds to the content of vinylamine groups in mol % in the polymers. The hydrolysis of the polymers described above is effected by known methods, by the action of acids (e.g. mineral acids, such as sulfuric acid, hydrochloric acid or phosphoric acid, carboxylic acids, such as formic acid or acetic acid, or sulfonic acids or phosphonic acids), bases or enzymes, as described, for example, in DE-A 31 28 478 and U.S. Pat. No. 6,132,558. When acids are used as hydrolyzing agents, the vinylamine units of the polymers are present as an ammonium salt, whereas the free amino groups form in the case of hydrolysis with bases.

In most cases, the degree of hydrolysis of the homo- and copolymers used is from 85 to 95 mol %. The degree of hydrolysis of the homopolymers is equivalent to the content of vinylamine units in the polymers. In the case of copolymers which comprise vinyl esters incorporated in the form of polymerized units, hydrolysis of the ester groups with formation of vinyl alcohol units may occur in addition to hydrolysis of the N-vinylformamide units. This is the case particularly when the hydrolysis of the copolymers is carried out in the presence of sodium hydroxide solution. Acrylonitrile incorporated in the form of polymerized units is also chemically modified during the hydrolysis. Here, for example, amido groups or carboxyl groups form. The homo- and copolymers comprising vinylamine units can, if appropriate, comprise up to 20 mol % of amidine units, which form, for example, by reaction of formic acid with two neighboring amino groups or by intramolecular reaction of an amino group with a neighboring amido group, for example of N-vinylformamide incorporated in the form of polymerized units.

The average molar masses Mw of the polymers comprising vinylamine units are, for example, from 500 to 10 million, preferably from 750 to 5 million and particularly preferably from 1000 to 2 million g/mol (determined by light scattering). This molar mass range corresponds, for example, to K values of from 30 to 150, preferably from 60 to 100 (determined according to H. Fikentscher in 5% strength aqueous sodium chloride solution at 25° C., a pH of 7 and a polymer concentration of 0.5% by weight). Polymers which comprise vinylamine units and have K values of from 85 to 95 are particularly preferably used.

The polymers comprising vinylamine units have, for example, a charge density (determined at pH 7) of from 0 to 18 meq/g, preferably from 5 to 18 meq/g and in particular from 10 to 16 meq/g.

The polymers comprising vinylamine units are preferably used in salt-free form. Salt-free aqueous solutions of polymers comprising vinylamine units can be prepared, for example, from the salt-containing polymer solutions described above with the aid of ultrafiltration over suitable membranes with cut-offs of, for example, from 1000 to 500 000 Dalton, preferably from 10 000 to 300 000 Dalton.

Derivatives of polymers comprising vinylamine units can also be used as creping assistants. Thus, for example, it is possible to prepare a multiplicity of suitable derivatives from the polymers comprising vinylamine units by amidation, alkylation, sulfonamide formation, urea formation, thiourea formation, carbamate formation, acylation, carboxymethylation, phosphonomethylation or Michael addition of the amino groups of the polymer. Of particular interest here are uncrosslinked polyvinylguanidines, which are obtainable by reaction of polymers comprising vinylamine units, preferably polyvinylamines, with cyanamide (R¹R²N—CN, where R¹ and R² are H, C₁- to C₄-alkyl, C₃- to C₆-cycloalkyl, phenyl, benzyl, alkyl-substituted phenyl or naphthyl), cf. U.S. Pat. No. 6,087,448, column 3, line 64 to column 5, line 14.

The polymers comprising vinylamine units also include hydrolyzed graft polymers of, for example, N-vinylformamide on polyalkylene glycols, polyvinyl acetate, polyvinyl alcohol, polyvinylformamides, polysaccharides, such as starch, oligosaccharides or monosaccharides. The graft polymers are obtainable by subjecting, for example, N-vinylformamide to free radical polymerization in an aqueous medium in the presence of at least one of said grafting bases, if appropriate together with other copolymerizable monomers, and then hydrolyzing the grafted-on vinylformamide units to vinylamine units in a known manner.

Preferred polymers comprising vinylamine units are vinylamine homopolymers of N-vinylformamide having a degree of hydrolysis of from 1 to 100 mol %, preferably from 25 to 100 mol %, and copolymers of N-vinylformamide and vinyl formate, vinyl acetate, vinyl propionate, acrylonitrile, methyl acrylate, ethyl acrylate and/or methyl methacrylate, having a degree of hydrolysis of from 1 to 100 mol %, preferably from 25 to 100 mol %, and K values of from 30 to 150, in particular from 60 to 100. The abovementioned homopolymers of N-vinylformamide are particularly preferably used in the process according to the invention.

These polymers comprising vinylamine units are used as adhesives in the process according to the invention.

The adhesive power of the polymers comprising vinylamine units on the moist paper sheet and the creping cylinder generally increases with increasing molecular weight of the polymers comprising vinylamine units. If the surface of a specific cylinder material is too tacky as a result of the polymer comprising vinylamine units which has just been used, the tack can be reduced by using a polymer comprising vinylamine units which has a lower molecular weight. If, on the other hand, the adhesion of the paper on the cylinder is too weak, it can be increased by using a polymer comprising vinylamine units which has a higher molecular weight. A further control quantity for the adhesion of the paper on the cylinder during the creping process is the degree of hydrolysis of the polymers comprising vinylamine units, a high degree of hydrolysis also meaning strong adhesion, which can be reduced by a lower degree of hydrolysis. Both possible controls can of course also be used together, the multiplicity of possibilities for adjustment being very great. Furthermore, the use of comonomers as described above influences the adhesive power of the polymers comprising vinylamine units on the moist paper sheet and the creping cylinder.

The above-described adhesives which are used according to the invention as creping assistants are usually used in from 0.05 to 15, preferably from 0.1 to 10, % strength by weight aqueous solutions or mixtures. The commercial products, which have a polymer concentration of, for example, from 10 to 30% by weight, are diluted before use as creping assistants by adding water or incorporated into the mixtures. The pH of the ready-to-use aqueous polymer solutions of the creping assistants is, for example, from 4 to 12, preferably from 6 to 10.

The invention also relates to the use of at least one polymer comprising vinylamine units as a creping assistant.

The polymers to be used according to the invention as creping assistants can, for example, be sprayed onto the wet paper web during the papermaking process or applied directly to the creping cylinder. However, it is also possible to subject a dried paper subsequently to a creping process. For this purpose, the dry paper is either first moistened with water (for example to a moisture content of from about 5 to 20% by weight) or directly sprayed with an aqueous solution of an adhesive, which solution is to be used according to the invention. Preferably, for example in modern TAD machines, the paper is fed in the dry state to the cylinder, which in turn is sprayed with the adhesive. The amount of adhesive applied can be chosen as desired; for example, it may be from 1 mg to 250 mg, preferably from 2 mg to 50 mg, per square meter of paper. The temperature of the creping cylinder is, for example, from 100 to 150° C., in general from 125 to 145° C.

The adhesives to be used according to the invention can be used either alone or as a mixture with one another. The mixture of the adhesives according to the invention and their mixtures with release agents, are also possible for better control of the adhesion on the creping cylinder, as is the mixing in of an additional adhesion promoter.

However, it is also possible to use the adhesives to be used according to the invention as a mixture with known creping assistants. Such mixtures may comprise, for example, from 10 to 90, preferably from 20 to 70, % by weight of at least one of the following organic synthetic polymers: polyvinyl alcohol, copolymers of ethylene and vinyl acetate, polyvinyl acetate, polyamidoamines, polyacrylates and polymethacrylates, polyacrylic acid and polymethacrylic acid, and polyethylenimines and polyalkylpolyamines. Said polymers and, if appropriate, further additives, such as release agents and anchoring agents, should be tested, before the preparation of the mixtures, for their compatibility with the adhesives to be used according to the invention, so that the components of the mixture do not mutually coagulate. Suitable release agents are, for example, mineral oils and surface-active compounds which additionally have a softening effect on the paper. Anchoring agents are, for example, water-soluble inorganic phosphates.

The following examples are intended to explain the invention, but without restricting it.

Unless evident otherwise from the context, the stated percentages in the examples are percent by weight. The K values were determined according to H. Fikentscher, Cellulose-Chemie, Vol. 13, 58-64 and 71-74 (1932), in 5% strength aqueous sodium chloride solution at a temperature of 25° C. and a pH of 7 and at a polymer concentration of 0.5% by weight.

### EXAMPLE 1

Lavatory crepe paper having a basis weight of about 20 g/m² and based on deinked wastepaper was produced on a paper machine. 0.4 g of a 10% strength aqueous solution of a polymer comprising vinylamine units (prepared by hydrolysis of poly-N-vinylformamide, degree of hydrolysis 90 mol %, K value 90) was sprayed continuously as an adhesive per square meter of paper, onto the creping cylinder with the aid of a spray bar. The creping of the paper took place without problems. No troublesome deposits and no signs at all of pitting were discovered on the creping cylinder during the experimental procedure and even thereafter. Scarcely any measurable traces of organic chlorine compounds which originated from the wastepaper used were found in the wastewater of the paper machine.

### COMPARATIVE EXAMPLE 1

Example 1 was repeated, with the only exception that 0.35 g of a 10% strength aqueous solution of a polyamidoamine/epichlorohydrin resin (Luresin® KNU from BASF Aktiengesellschaft), known as wet strength agent, was now sprayed as an adhesive with the aid of a spray bar onto the creping cylinder. After only a short time, troublesome deposits formed on the creping cylinder, so that the paper production had to be stopped and the creping cylinder had to be reground. Moreover, as a result of recycling the production waste, the edge trims and other processing residues, chlorine compounds entered the water circulation of the paper machine.

1. A process for the production of crepe paper by adhesive bonding of a paper web with the aid of an organic synthetic polymer or mixtures comprising said polymer, as an adhesive, to a creping cylinder, compression and removal of the crepe paper from the creping cylinder, where the organic synthetic polymer used is at least one polymer comprising vinylamine units, which are homo- and copolymers of N-vinylformamide which have a degree of hydrolysis of from 1 to 100 mol %, wherein the polymers comprising vinylamine units have an average molecular weight of from 1000 to 2 million g/mol.

2. The process according to claim 1, wherein said polymers are homopolymers of N-vinylformamide.

3. The process according to claim 1, wherein said polymers are copolymers comprising
from 95 to 5 mol % of N-vinylformamide and
from 5 to 95 mol % of monoethylenically unsaturated monomers.

4. The process according to claim 3, wherein the monoethylenically unsaturated monomers are selected from vinyl formate, vinyl acetate, acrylonitrile, methyl acrylate, ethyl acrylate and methyl methacrylate.

5. The process according to claim 1, wherein the polymers comprising vinylamine units are used as an adhesive mixed with at least one organic synthetic polymer from the group consisting of the polyvinyl alcohols, copolymers of ethylene and vinyl acetate, polyvinyl acetates, polyamidoamines, polyacrylates and polymethacrylates, polyacrylic acid and polymethacrylic acid, and polyethylenimines and polyalkylpolyamines.

6. The process according to claim 1, wherein the adhesives comprise a release agent.

7. The process according to claim 1, wherein from 1 to 250 mg of adhesive are used per square meter of paper.

8. (canceled)

9. A process for producing crepe paper comprising spraying onto a paper web a creping assistant comprising at least one polymer having vinylamine units according to claim 1.

10. A process for producing crepe paper comprising applying to a creping cylinder a creping assistant comprising at least one polymer having vinylamine units according to claim 1.
